(19) United States
(12) Patent Application Publication
(10) Pub. No.: US 2009/0196490 A1
(43) Pub. Date: Aug. 6, 2009

(54) DEFECT INSPECTION METHOD AND DEFECT INSPECTION APPARATUS

(75) Inventor: Yasuo MATSUMIYA, Kawasaki (JP)

Correspondence Address: Fujitsu Patent Center;C/O CPA Global, P.O. Box 52050, Minneapolis, MN, 55402, US

(73) Assignee: FUJITSU MICROELECTRONICS LIMITED, Tokyo (JP)

(21) Appl. No.: 12/367,444

(22) Filed: Feb. 6, 2009

(30) Foreign Application Priority Data
Feb. 6, 2008 (JP) 2008-026427

(51) Int. Cl. G06K 9/00

(52) U.S. Cl. 382/149

(57) ABSTRACT

A method, of inspecting a semiconductor device for defects, includes: acquiring an observation image of the semiconductor device, the observation image including a defect inspection object area which has a repetitive pattern; superposing a reference on the observation image thereby to form a test-mule image representing a version of the observation image in which signals have been removed from a given area, including the defect inspection area, masked with the reference ; and inspecting for defects in the test-mule image thereby to identify corresponding defects in the observation image.

### CROSS-REFERENCE TO RELATED APPLICATION

This application is based upon and claims the benefit of priority from the prior Japanese Patent Application No. 2008-26427 filed on Feb. 6, 2008, the entire contents of which are incorporated herein by reference.

### BACKGROUND

1. Field

The present invention relates to a defect inspection method and a defect inspection apparatus.

2. Description of Related Art

In a semiconductor manufacturing process, in-line defect inspections are frequently implemented for the purposes of enhancing the yield of wafers to be manufactured and supervising a manufacturing line. With the microfabrication of semiconductor patterns, defect inspection apparatuses of electron microscope scheme have come to be used in recent years. When an electron microscope such as a scanning electron microscope (SEM) or the like is employed, even a small defect which is difficult to be seen with a defect inspection apparatus of optical type becomes detectable, and besides, internal electrical defects such as short-circuiting and nonconduction, i.e., an at least substantially open-circuit condition or at least substantially disconnected condition, the nonconduction representing a high impedance and/or a non-ohmic contact, become detectable.

JP-A-2004-257845 teaches that surface defects such as a surface pattern defect and foreign matter adhesion, and defects that exhibit a contrast is neighboring voltages, i.e., voltage contrast (VC) defects, such as short-circuiting and nonconduction, are ascribable to different causes, so they should be distinguished. More particularly, it proposes a technique wherein the images of defect candidates containing surface patterns are extracted by processing a SEM image, the degrees of the overlap magnitudes or shift magnitudes between the pixel values of the respective patterns and defects are calculated, and the defect candidates are classified into the surface defects, the VC defects and false information on the basis of the degrees.

In the defect inspection apparatus of the electron microscope scheme, the adjustment of an observation condition is technically more difficult than in the optical type defect inspection apparatus. Especially in a defect inspection utilizing a voltage contrast (VC), various contrivances are made in order to obtain stable images. There has been known, for example, a method wherein a surface to be observed is once charged up uniformly in order to stabilize the VC.

JP-A-2006-40991 proposes a technique wherein a wafer surface to which plugs are exposed is irradiated with electron beams a plurality of times at predetermined intervals, under a condition which a p-n junction is reverse-biased; an electron beam irradiation condition is changed while the charged state of the plug surface is being monitored; and the secondary electron signals of a circuit pattern are acquired under a condition which charging that is relieved in accordance with a leakage current falls within a desired range, thereby to estimate a leakage characteristic.

JP-A-2006-208367 teaches that, when the potential of a power source for a charging control electrode over a wafer is lowered, the brightness of an image lowers, and that an area of constant brightness is in a positively charged state, whereas a darkening area is in a negatively charged state. Concretely, it proposes a technique wherein that point of change in the brightness which is the boundary between the positively charged state and the negatively charged state is in a weakly charged state, and the point of change is set as an inspection condition, thereby to perform the stable inspection of the wafer with a charging quantity suppressed.

An image based on secondary electrons contains components dependent upon the three-dimensional shape of an object to-be-inspected (hereinbelow, called the “edge components”), etc. in addition to voltage-based contrast (VC) components. When the edge components are intense, the VC components often become difficult to be detected.

### SUMMARY

An embodiment of the present invention provides a method, of inspecting a semiconductor device for defects, including: acquiring an observation image of the semiconductor device, the observation image including a defect inspection object area which has a repetitive pattern; superposing a reference on the observation image thereby to form a test-mule image representing a version of the observation image in which signals have been removed from a given area, including the defect inspection area, masked with the reference ; and inspecting for defects in the test-mule image thereby to identify corresponding defects in the observation image.

Other features and advantages of embodiments of the present invention are apparent from the detailed specification and, thus, are intended to fall within the scope of the appended claims. Further, because numerous modifications and changes will be apparent to those skilled in the art based on the description herein, it is not desired to limit the embodiments of the present invention to the exact construction and operation illustrated and described, and accordingly all suitable modifications and equivalents are included.

### BRIEF DESCRIPTION OF THE DRAWINGS

Embodiments are illustrated by way of example and not limited in by the following figures.

FIGS. 1A and 1B are the observation images of a surface formed with conductive plugs which have been acquired with an electron microscope, respectively;

FIG. 1C is the differential image between an image 1 in FIG. 1A and an image 2 in FIG. 1B;

FIG. 1D is an pixel intensity distribution diagram;

FIG. 2A is a plan view showing an SRAM circuit area;

FIG. 2B is a sectional view showing a gate electrode portion;

FIGS. 2C and 2D are observation images for an identical SRAM area as have been acquired with two electron microscopes of different observation conditions, respectively;

FIG. 3A is a block diagram showing a defect inspection apparatus according to an example embodiment of the present invention;

FIGS. 3B and 3C are schematic views showing the configurations of a wafer and a chip, respectively;

FIG. 3D is a flow chart showing a defect inspection method according to an example embodiment of the present invention;

FIG. 4A is an observation image which has been acquired in such a way (according to an example embodiment of the present invention) that an insulating layer surface with aligned W (tungsten) plugs is observable;

FIG. 4B is a worked image which has been manipulated in such a way (according to an example embodiment of the present invention) that contours of the observation image in FIG. 4A have been extracted;

FIG. 4C is a diagram showing the superposition between the worked image and a pattern image obtained as a result of applying (according to an example embodiment of the present invention) pattern matching to the same;

FIG. 4D is an image which has been obtained by superposing a reference image on the observation image, and then removing the signals of W plug parts according to an example embodiment of the present invention;

FIG. 4E is a differential image which has been generated for two areas having an identical pattern, by using (according to an example embodiment of the present invention) repetitive information;

FIG. 4F is an image which has been binarized (according to an example embodiment of the present invention) by, e.g., applying a threshold value to the differential image in FIG. 4E;

FIG. 5A shows an observation image of an SRAM area imaged under observation conditions established according to an example embodiment of the present invention);

FIG. 5B is an image which has been obtained by binarizing (according to an example embodiment of the present invention) the observation image in FIG. 5A;

FIG. 5C shows a reference image for pattern matching according to an example embodiment of the present invention;

FIG. 5D is a reference image for masking active regions according to an example embodiment of the present invention;

FIG. 5E is a diagram showing (according to an example embodiment of the present invention) the superposition between the observation image in FIG. 5A and the reference image in FIG. 5D; and

FIG. 5F is the image of a gate electrode having a short-circuiting defect which has been detected (according to an example embodiment of the present invention) using an inspecting image with noise components reduced.

In the drawings, relative thicknesses and positioning of layers or regions may be reduced or exaggerated for clarity. In other words, the figures are not drawn to scale. Further, a layer is considered as being formed “on” another layer or a substrate when formed either directly on the referenced layer or the substrate or formed on other layers or patterns overlaying the referenced layer.

### DESCRIPTION OF EMBODIMENTS

A comparative example of the defect detection of a semiconductor device based on a defect detection apparatus employing an imager, e.g., an electron microscope, will be explained before the description of embodiments.

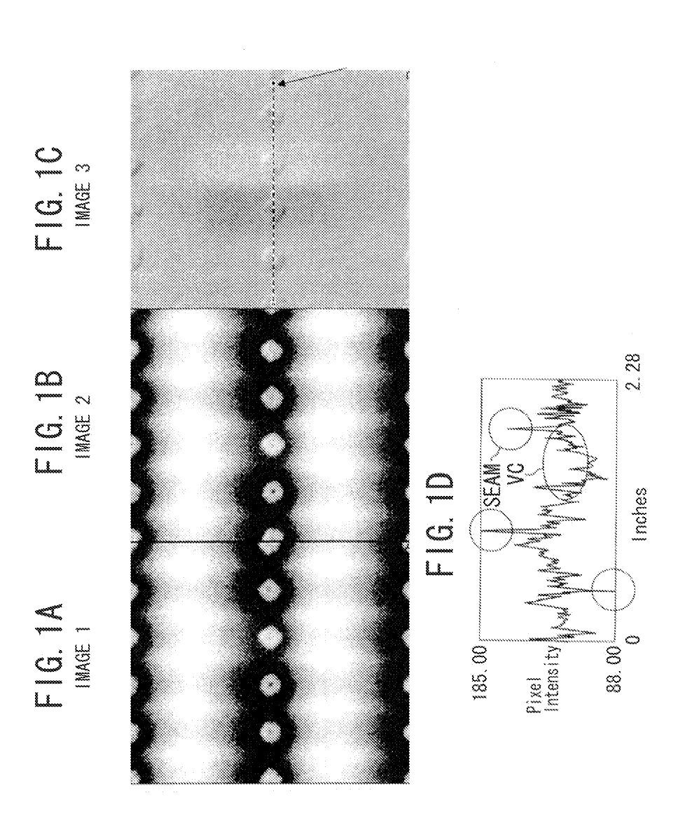

FIGS. 1A and 1B are observation images acquired with an electron microscope for a surface in the case where a silicon substrate formed MOS transistors has been covered with an insulating film and where conductive plugs of tungsten (W) penetrating through the insulating film to reach the MOS transistors have been formed, respectively. The W plugs ought to be electrically connected to underlying conductive layers, but the defects of nonconductions can occur. For example, nonconduction may be the result of step coverage voids. The W plugs are arranged in a repetition cycle in a lateral direction. A W layer is deposited by chemical vapor deposition (CVD). At the middle parts of the W plugs, step coverage seams ascribable to process conditions appear randomly. In a defect inspection, singularity parts are extracted by taking the differences between corresponding pixel values of the repetition images.

FIG. 1C is the differential image between the image 1 in FIG. 1A and the image 2 in FIG. 1B. FIG. 1D shows an electron intensity distribution along a straight line (called out in FIG. 1C) which laterally traverses the centers of the W plugs in FIG. 1C. Although the VCs of the seam parts are significant, the influence of the seams upon the yield of wafers is relatively insignifcant. The inferior contact (nonconduction) of the W plug also can be observed as a VC defect, though it relatively significantly, if not substantially, can influence the yield. In the pixel value intensity distribution in FIG. 1D, which represents an pixel intensity distribution, the differences between adjacent pixel values that correspond to, i.e., the VC defect ascribable to, the inferior contact appear to be small, and hence, the automatic detection thereof is difficult.

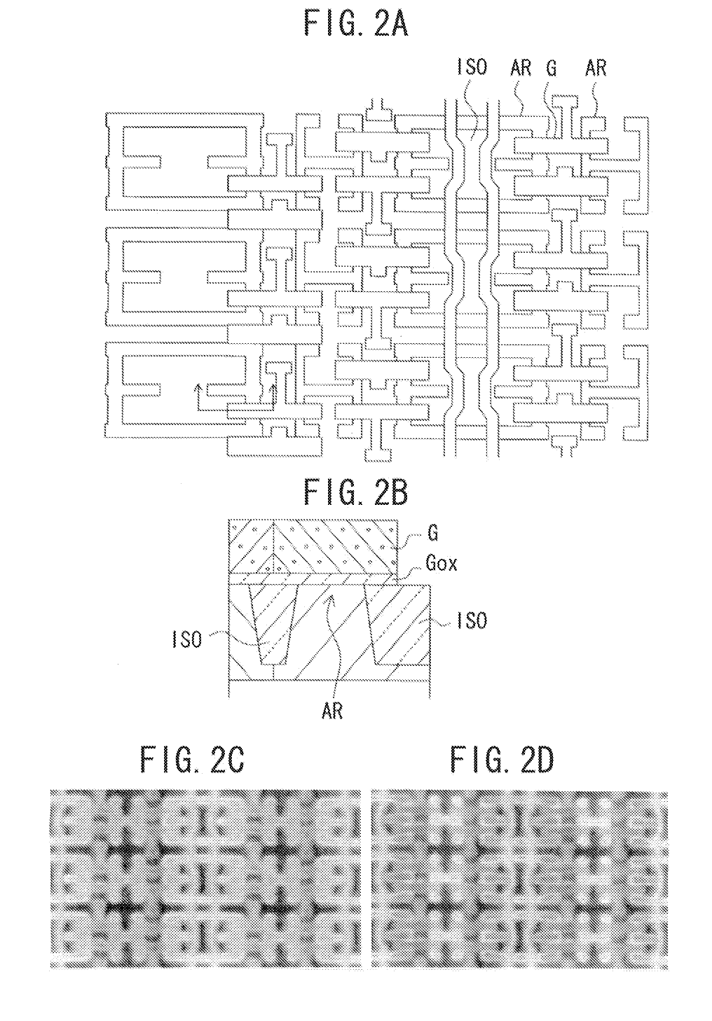

FIG. 2A is a plan view of an SRAM circuit area. An active region AR is defined by being surrounded with an element isolation region ISO, and a gate electrode G is formed through a gate insulating film while traversing the active regions.

FIG. 2B is a sectional view of a gate electrode portion. The element isolation region ISO is formed in such a way that a trench is formed in a silicon substrate, and that an insulating film of silicon oxide or the like is buried into the trench. The active region AR is defined by the element isolation region ISO. The gate electrode G is formed, e.g., of polysilicon over the active region and on, e.g., the gate insulating film Gox. The gate electrode G ought to be insulated from the active region AR by the gate insulating film Gox, but a defect of short-circuiting to the active region can occur.

FIGS. 2C and 2D are the observation images of the identical SRAM area which have been acquired with two imagers, e.g., electron microscopes, of different observation conditions, respectively. Under the condition in FIG. 2C, a contrast in and around the active region is relatively low, and the VC defect ascribable to the short-circuiting of the gate electrode to the active region is relatively difficult to see. Under the condition in FIG. 2D, a contrast in and around the active region is relatively high, and the VC defect of the gate electrode is relatively easy to be seen.

Without being bound by theory, in order to detect the VC defect more easily and/or consistently during defect inspection of a repetitive pattern, the inventor has thought that a voltage contrast signal to be detected can be made more conspicuous by masking and removing a voltage contrast signal which exhibits a substantial change, but which does not exert substantial influence on the yield, e.g., such as a voltage constrast signal corresponding to a seam. In other words, vis-à-vis voltage contrast signals representing nonconduction types of defects, the inventor has thought to treat as noise voltage contrast signals representing seams.

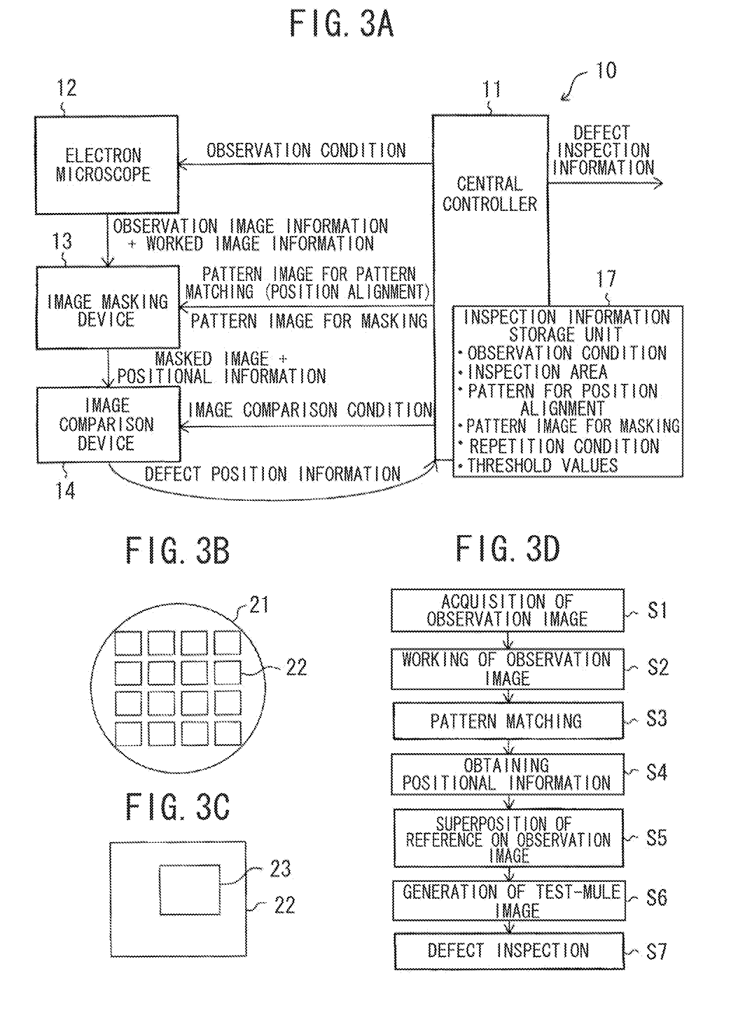

FIG. 3A is a block diagram showing the configuration of a defect inspection apparatus according to an example embodiment of the present invention. The defect inspection apparatus 10 includes a controller 11, an imager, e.g., electron microscope, 12, an image masking device 13 and an image comparison device 14. The controller 11 includes a memory 17 which stores therein inspection information items such as an observation condition, an inspection area, a pattern for position alignment, a masking pattern, a repetition condition and threshold values.

FIG. 3B is a plan view showing a silicon wafer which is an object to-be-inspected. The silicon wafer 21 is formed with a plurality of chips 22. For the brevity of illustration, a case where the 4×4 chips 22 are formed is illustrated, but the actual number of chips typically is large. By way of example, the silicon wafer has a diameter of 30 cm, and one side of each chip is on the order of 0.5 cm to 3 cm.

FIG. 3C is a schematic plan view of one chip. An object whose defects are to be inspected is the region 23 of an SRAM or the like which has the structure of a repetitive pattern within the chip 22.

Structures in the individual semiconductor chips are based on design data, and the design data of planar configurations at individual levels are uniform. Various pattern images can be formed on the basis of these design data. It is possible to create, for example, a pattern image for position alignment (pattern matching) which may be utilized for fixation of a position, and a reference image which may define an area for intercepting any unnecessary VC signal. Incidentally, these pattern images can also be created on the basis of the observation images of samples actually formed.

Referring back to FIG. 3A, the controller 11 provides the observation condition to the electron microscope 12, the pattern-matching reference image and the reference image to the image masking device 13, and an image comparison condition to the image comparison device 14.

In the electron microscope 12, the electron microscope image of a defect inspection object area is observed in accordance with the observation condition, and observation image information is subjected to workings/manipulations such as contour extraction and binarization, thereby to create simplified worked image information for use in pattern matching for position alignment. The observation image information is provided from the electron microscope 12 to the image masking device 13, together with the worked image information.

In the image masking device 13, the worked image information containing contour information, binarized image information, etc. and the reference image (provided from the controller 11) are subjected to the position alignment via pattern matching. As a result, positional information is obtained for a state where the worked image information and the pattern image coincide significantly, if not substantially, if not maximally. The reference image is superposed on the observation image on the basis of the positional information, and a masked image in which the signals of an area masked by the reference image have been removed is created. The masked image is provided to the image comparison device 14, together with the positional information. Using the masked image, the image comparison device 14 forms a differential image and performs a comparison inspection, thereby to inspect defects. The positional information items of the defects (defect position information items) are provided to the controller 11. The controller 11 outputs defect inspection information items such as the defect position information items, the (vertical and lateral) sizes of the defects, and the intensities of difference signals in the case where the defect inspection was implemented.

FIG. 3D is a flow chart of a defect inspection method according to an example embodiment of the present invention, which may be performed with, e.g., the defect inspection apparatus shown in FIG. 3A.

At a step S1, an observation image is acquired with an imager, e.g., an electron microscope. At a step S2, the observation image is subjected to workings such as contour extraction and binarization, thereby to obtain a worked image. At a step S3, the worked image is aligned with a reference image and then pattern matching is performed between the worked image and the reference image thereby to determine a desired registration relationship of the worked image relative to the reference image, e.g., a registration that achieves optimal VC signal coincidence. At a step S4, positional information is obtained on the basis of the desired registration relationship. At a step S5, a reference image is superposed on the observation image on the basis of the positional information. At a step S6, a test-mule image is generated, the test-mule image representing a version of the observation image in which noise signals, e.g., VC signals corresponding to seams, have been removed. At a step S7, defects are detected using the test-mule image.

Next there will be described an example in which VC inspection is made of W plugs that are formed so as to penetrate through an insulating layer. The W plugs are conductive members which electrically lead out the source/drain regions of MOS transistors, and so they need to be connected to underlying conductive layers at their bottoms. States where the W plugs are nonconductive relative to the underlying conductive layers of the source/drain regions represent defects. Although such nonconductive defects cannot be detected by typical optical inspection, they become detectable by the VC inspection employing an electron microscope.

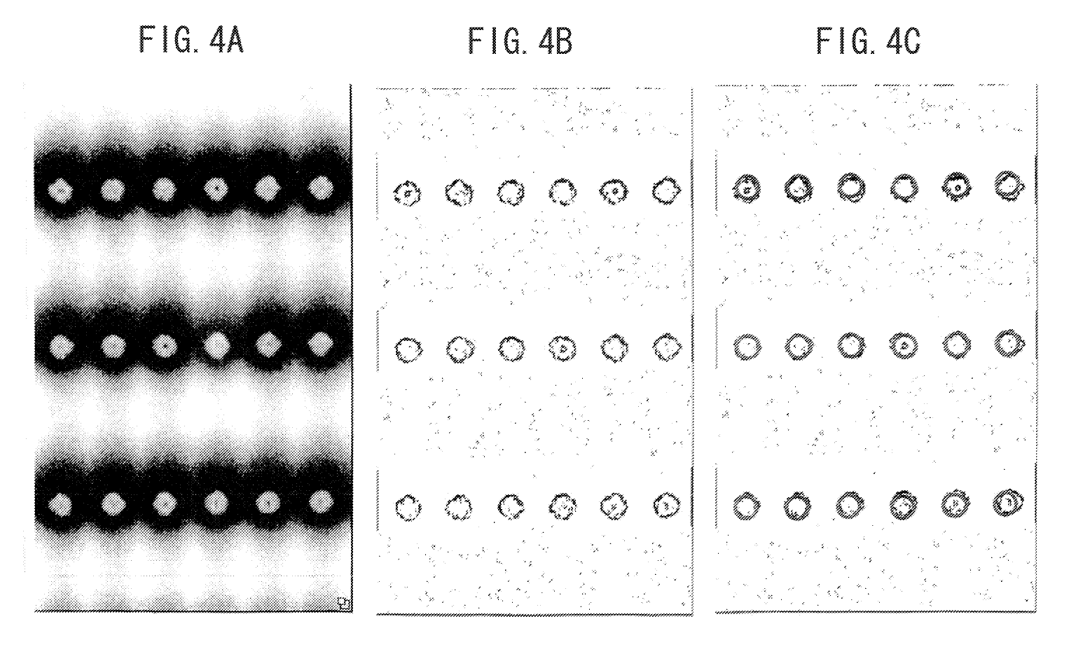

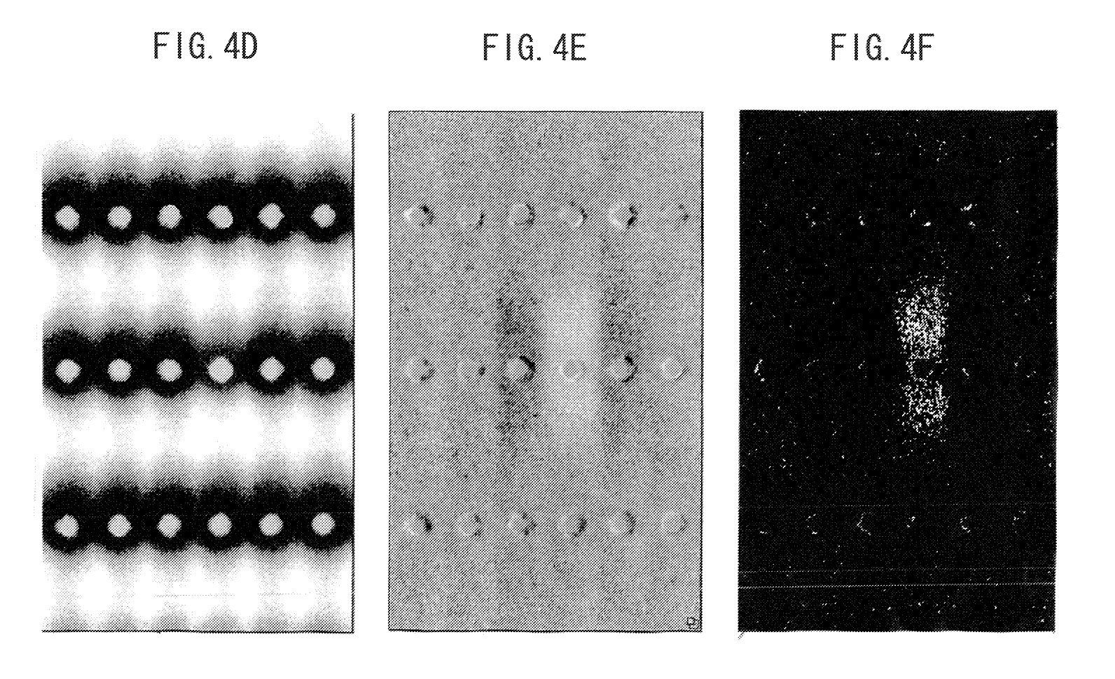

FIG. 4A is an observation image which has been acquired in such a way (according to an example embodiment of the present invention), e.g., via the electron microscope 12, that an insulating layer surface having aligned W plugs is observable. The nonconductions of the W plugs are detectable on the basis of the voltage contrast of the parts of the insulating film surface around the W plugs. The W plugs randomly have seams, and the presence of the seams generates relatively large VC signals when a differential image is formed. The voltage contrast of the insulating film surface exhibits comparatively small VC signals, and it is difficult to distinguish nonconduction parts of the W plugs from seams thereof.

FIG. 4B is a worked image which has been manipulated in such a way (according to an example embodiment of the present invention) that contours of the observation image in FIG. 4A have been extracted. That is, the observation image of FIG. 4A has been subjected, e.g., to a contour extraction process so as to extract the contours. A reason motivating performance of the contour extraction is to obtain positional information at the superposition of a masking image on the observation image, resulting in a pattern image of simplified information. The pattern image may be subjected to pattern matching process relative to reference image, e.g., stored beforehand. The controller 11 stores therein the corresponding reference image, and provides this reference image to the image masking 12.

FIG. 4C shows a result of applying (according to an example embodiment of the present invention) a pattern matching process to the worked image and the reference image. When significant coincidence is recognized, corresponding positional information may be obtained. The reference image may be superposed on the observation image on the basis, e.g., of the positional information.

FIG. 4D shows an image which has been obtained in such a way (according to an example embodiment of the present invention) that the reference image is superposed on the observation image, and that the signals of the W plug parts are removed. Here, the presence and absence of the seams have been removed from the resulting signals. The images of repetitive patterns become more cyclic.

FIG. 4E shows a differential image which has been generated from two areas having an identical pattern, by using (according to an example embodiment of the present invention) repetitive information, e.g., stored beforehand. Places which look whitish correspond to the voltage contrasts indicating the nonconductions of the W plugs.

FIG. 4F is an image which has been obtained in such a way (according to an example embodiment of the present invention) that the differential image in FIG. 4E is quantized, e.g., binarized, e.g., by applying a threshold value, e.g., stored beforehand. Here, the VC defects corresponding to nonconductions are more easily detected. A defect inspection of enhanced reliability can be realized by masking areas where the changes of a signal intensity are relatively large, so as to leave only the signals of areas to-be-inspected behind.

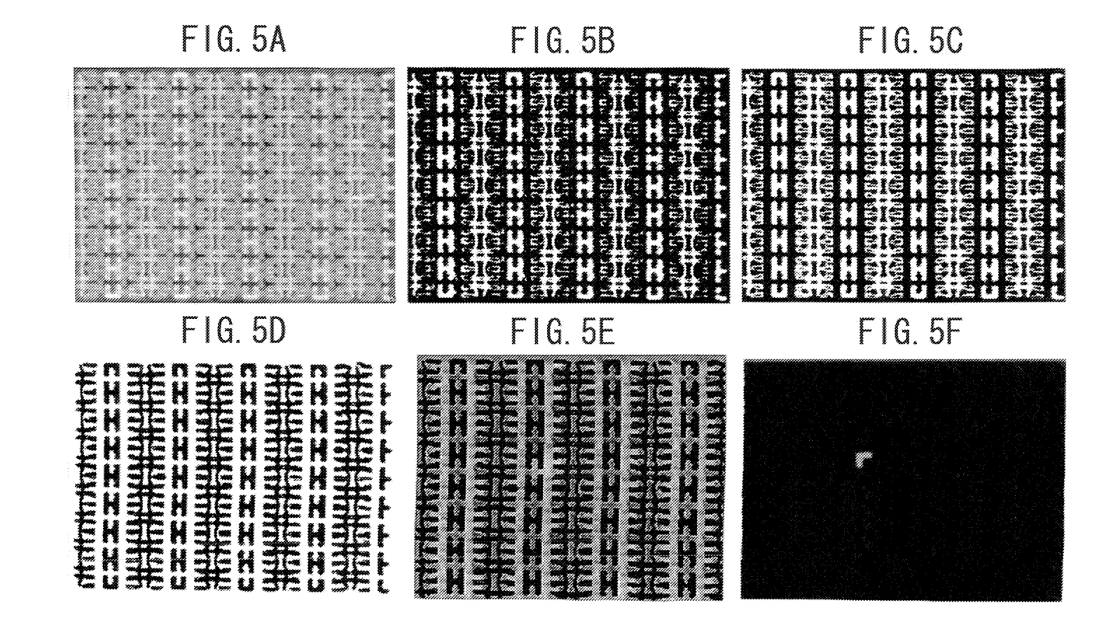

Next, by reference to FIGS. 5A-5F, there will be described an example that assumes a case where a defect is has been detected in an SRAM area such that the gate electrode of a MOS transistor is short-circuited to a channel region.

FIG. 5A shows an observation image of the SRAM area imaged under observation conditions established according to an example embodiment of the present invention.

FIG. 5B shows an image which has been obtained in such a way (according to an example embodiment of the present invention) that the observation image in FIG. 5A is quantized, e.g., binarized, e.g., by applying a threshold value. The binarization has an effect of emphasizing positional information in image information.

FIG. 5C shows a reference image according to an example embodiment of the present invention. The reference image has a pattern corresponding to the binarized image in FIG. 5B. Pattern matching is performed using the binarized image in FIG. 5B and the reference image in FIG. 5C, and positional information may be obtained corresponding to a state at a time when significant, if not substantial, if not maximal, coincidence has been established.

FIG. 5D shows a reference image for masking active regions according to an example embodiment of the present invention.

FIG. 5E shows a state where the reference image in FIG. 5D is superposed (according to an example embodiment of the present invention) on the observation image in FIG. 5A by using, e.g., the positional information. Test-mule image information obtained by removing the information of the masked regions is generated, thereby to obtain the image information which is free from the information of the active regions where brightness and darkness disperse largely.

FIG. 5F is the image of the gate electrode having the short-circuiting defect which has been detected (according to an example embodiment of the present invention) using such an inspecting image with noise components reduced.

Incidentally, the case where the gate electrodes are inspected by masking the active regions has been described, but the active regions can also be inspected by masking the gate electrodes.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is

1. A method of inspecting a semiconductor device for defects, the method comprising:
acquiring an observation image of the semiconductor device, the observation image including a defect inspection object area which has a repetitive pattern;
superposing a reference on the observation image thereby to form a test-mule image representing a version of the observation image in which signals have been removed from a given area, including the defect inspection area, masked with the reference; and
inspecting for defects in the test-mule image thereby to identify corresponding defects in the observation image.

2. The method as defined in claim 1, further comprising:
working the observation image so as to extract a worked image;
aligning the worked image and a reference image;
performing pattern matching between the worked image and the reference image so as to determine a desired registration relationship there between; and
obtaining positional information on the basis of the desired registration relationship;
wherein the superposing is performed on the basis of the positional information.

3. The method as defined in claim 1, wherein the superposing obtains the test-mule image by forming a differential image between corresponding parts of repetitive patterns in the reference and the observation image.

4. The method as defined in claim 1, wherein the inspecting uses a voltage contrast.

5. The method as defined in claim 1, wherein the defect inspection object area having the repetitive pattern is an area where contact plugs are embedded in an insulating film, and the reference image masks the contact plugs.

6. The method as defined in claim 1, wherein the defect inspection object area having the repetitive pattern is a MOS transistor area where gate electrodes are formed over active regions, and the reference image masks the active regions or the gate electrodes.

7. The method as defined in claim 1, wherein the acquiring an observation image acquires the same from an electron microscope.

8. The method as defined in claim 1, wherein the removed signals represent seams.

9. The method as defined in claim 1, further comprising: selecting as the reference image a member from the group consisting of a pattern which masks contact plugs, a pattern which masks active regions of a MOS transistor area, and a pattern which masks gate electrodes of the MOS transistor area.

10. An apparatus to inspect for defects in a semiconductor device, the apparatus comprising:
an imager to obtain an observation image of the semiconductor device, the observation image including a defect inspection object area which has a repetitive pattern;
an image masking device to work the observation image so as to extract a worked image, to superpose a reference image on the observation image thereby to form a test-mule image representing a version of the observation image in which signals have been removed from a given area, including the defect inspection area, masked with the masking pattern;
an image comparison device to inspect defects in the test-mule image thereby to identify corresponding defects in the observation image.

11. The apparatus as defined in claim 10, wherein:
said imager extracts a worked image for use in pattern matching for position alignment from the observation image; and
said image masking device performs pattern matching between the worked image and the reference image so as to determine a desired registration relationship there between, obtains positional information on the basis of the desired registration relationship; and superposes on the basis of the positional information.

12. The apparatus as defined in claim 10, wherein said image comparison device forms a differential image and detects a voltage contrast.

13. The apparatus as defined in claim 10, wherein the reference image is a member selected from the group consisting of a pattern which masks contact plugs, a pattern which masks active regions of a MOS transistor area, and a pattern which masks gate electrodes of the MOS transistor area.

14. The apparatus as defined in claim 10, wherein the imager is an electron microscope.

15. The apparatus as defined in claim 10, further comprising:
a memory to store the masking pattern; and
a controller to provide the reference to said image masking device, and to receive defect information from said image comparison device.

16. The apparatus as defined in claim 10, wherein the removed signals represent seams.
